(19) United States
(12) Patent Application Publication
(10) Pub. No.: US 2011/0119352 A1
(43) Pub. Date: May 19, 2011

(54) Method of mutual browsing and computer program therefor

(75) Inventors: Sergey Perov, San Francisco, CA (US); Elizabeth Yin, Berkeley, CA (US)

(73) Assignee: Parrotview, Inc.

(21) Appl. No.: 12/590,835

(22) Filed: Nov. 16, 2009

(51) Int. Cl. G06F 15/16

(52) U.S. Cl. 709/218

(57) ABSTRACT

A method of mutually co-browsing websites from the Internet comprises receiving code and objects from a first website from the Internet by a first client computer and display the code and objects in a main display. The first client computer transmits the URL of the first website to a second client computer. The first client computer also has a miniature display overlapping a portion of the main display. The first client computer can receive the URL of the second website that is being viewed by the second client computer. The first client computer receives an object from the second website and displays it in the miniature display. The first user at the first client computer can click or activate the miniature display to cause the code and object from the second website to be displayed in the main display. The present invention also contemplates using Javascript code embedded in the first and second websites to accomplish the foregoing. The second user, similarly has a main display portion to display the contents of the second website and an overlapping miniature display to display an object from the first website being viewed by the first client computer. The users can also simultaneously engage in a chat session regarding the websites displayed.

### TECHNICAL FIELD

The present invention relates to a method of browsing a network of interconnected computer networks, commonly and hereinafter called the “Internet” by two or more people who are in communication with one another. The present invention also relates to a computer program therefor.

### BACKGROUND OF THE INVENTION

The Internet is well known in the art. Each computer, or computer network, connected to the Internet has a unique address referred to as a Uniform Resource Locator (URL), also referred to as a website. A computer, operated by a user, called a client computer typically executes a browser program, such as the Internet Explorer offered by Microsoft Corporation or the Firefox browser offered by the Mozilla Foundation, that allows the client computer to browse the Internet by accessing the various URLs. At each URL, a server computer stores the code and data (called “object”) of the web page. The data or objects can be data or yet further link to data at another website or URL. The server computer responds to the browser from the client computer by supplying the client computer with the necessary code (typically in HTML format) and the objects operated upon by the code. The code and objects once delivered to the client computer through the Internet is assembled by the web browser program of the client computer into the web page for display on the display device of the client computer.

As the Internet has become more useful in social settings, it is desirable to incorporate the basic browsing experience into a social browsing experience. Thus, for example, it is desirable for a first user at a first client computer operating a web browser program to access a web page from a website to be able to view that web page, in real time, with a second user at a second client computer operating another web browser program, and vice versa. In that manner the two users can engage, critique, analyze, or otherwise share comments with regard to the web page being commonly viewed at the same time. U.S. Pat. No. 5,944,791 and its continuation U.S. Pat. No. 6,263,365 describe a system and a method for browsing the Internet whereby two different users operating two different client computers can view at the same time the same web page thereby share the same browsing experience. Referring to FIG. 1 there is shown a block level diagram of a system 10 of the prior art, such as that disclosed in the aforementioned patents, for collaboratively browsing the Internet 12 in real time. The system 10 comprises a first server computer 14 connected to the Internet 12. Thus, the first server computer 14 is a part of the Internet. However, for discussion purpose, the first server computer 14 is referred to as separate from the Internet 12. A second server computer 20 is connected to the Internet 12, and is also a part of the Internet. Again for discussion purpose, the second server computer 20 is referred to as being separate from the Internet 12. The second server computer 20 contains the web page of interest to a first client computer 16 and a second client computer 18. The first client computer 16 is connected to the first server computer 14 and to the Internet 12. A second client computer 18 is also connected to the first server computer 14 and to the Internet 12.

When a first user operating the first client computer 16 desires to collaboratively browse the Internet 12 with, e.g. a second user operating the second client computer 18, at a website, such as the website 20, the first client computer 16 issues the URL of the second server computer 20 through the first server computer 14. The first server computer 14 then sends the URL of the second server computer 20 and receives the code and objects of the webpage from the website operated by the second server computer 20 and delivers them to both the first client computer 16 and the second client computer 18, simultaneously. In this method, in effect the first server computer 14 is acting like a client computer accessing the website 20.

There are a number of drawbacks to this system and method of the prior art. First, as best understood, after the first server computer 14 receives the code and objects from the website 20, it frames that code and objects within another frame (its frame) for delivery to the first and second client computers 16 and 18. Thus, in the system 10, the code and objects from the website 20 are framed in a frame. However, because of so-called “frame-buster” codes that are used by many websites to thwart the framing of their website codes and objects within another frame, when used with a web browser, the system 10 may not function properly at all websites. Second, the system 10 does not appear to permit the first client computer 16 to view a website different from the website being viewed by the second client computer 18 with each of the first client computer 16 and the second client computer 18 knowing what URL or website the other client computer is viewing.

U.S. patent application Ser. No. 12/380,263 filed on Feb. 26, 2009 and assigned to the same assignee as the present application, discloses a method of browsing as well as a computer program therefor for browsing a first website by a first client computer, with a second client computer viewing the first website being viewed by the first client computer. In this so-called lead-follower model, however, the follower (second client computer) always views only the website being viewed by the first client computer (lead).

It is therefore, one object of the present invention to develop a system, method and computer program to allow mutual co-browsing of the Internet in an efficient and enjoyable experience.

### SUMMARY OF THE INVENTION

Accordingly, in the present invention, a method of browsing a website from a plurality of websites from the Internet is disclosed. Each website has an address associated therewith. The method comprises receiving code and objects from a first website from the Internet by a first computer. The code and objects of the first website are displayed on a display area of a display device of the first computer. A second computer receives code and objects from a second website from the Internet. The second computer displays the code and objects of the second website on a display area of a display device of the second computer. The first computer transmits a first address associated with the first website to a server computer to send to the second computer. The second computer receives a first object from the first address and displays the first object from the first address in a first portion of the display area of the display device of the second computer. The first portion overlays a portion of the display area.

The present invention also relates to a computer program embodied in a machine readable storage medium for reference by a website that has a first address. The computer program is downloaded to a first computer for execution. The computer program comprises computer program code configured to cause the first computer to initiate a communication session through a server computer with a second computer. In addition, the computer program code is configured to cause the first computer to transmit to the server computer the first address.

The present invention also relates to a server computer program embodied in a machine readable storage medium for execution by a server computer. The server computer program comprises computer program code configured to receive identification data for logging a first user from a first computer on to a chat server computer, and the identification of a second user with whom the first user desires to communicate. The server computer program further comprises computer program code configured to log on to the chat server computer and to initiate communication with the second user, as if the server computer were the first computer. Finally, the server computer program comprises computer program code configured to communicate directly with the second user at a second computer and with the first user at the first computer once communication is established by the chat server computer, and by passing the chat server computer.

The present invention also relates to a web browser computer program embodied in a machine readable storage medium for execution by a first computer. The web browser computer program comprises computer program code configured to cause the first computer to receive first code and objects from a first address of a website from the Internet, and to display same on a first display. The web browser computer program further comprises computer program code configured to transmit the first address to a server computer, for delivery to a second computer. Finally, the web browser computer program comprises computer program code configured to receive from the server computer in a portion of the first display an object from a website displayed at the second computer.

The present invention also relates to an extension computer program for a web browser computer program embodied in a machine readable storage medium for execution by a first computer. The extension computer program comprises computer program code configured to cause the web browser computer program of the first computer to receive first code and objects from a first address of a website from the Internet, and to cause the web browser computer program to display same on a first display. The extension computer program also comprises computer program code configured to transmit the first address to the server computer, for delivery to a second computer. Finally, the extension computer program comprises computer program code configured to receive from the server computer and to cause the web browser computer program to display in a portion of the first display an object from a website displayed at the second computer.

### BRIEF DESCRIPTION OF THE DRAWINGS

FIG. 1 is a schematic diagram of a system of the prior art.

FIG. 2 is a schematic diagram of a system for implementing one embodiment of the present invention.

FIG. 3 is a schematic diagram of a system showing the flow of chat information in accordance with the present invention.

FIG. 4 is a schematic diagram of a screen shot showing the display on the monitor at either the first client computer or the second client computer.

### DETAILED DESCRIPTION OF THE INVENTION

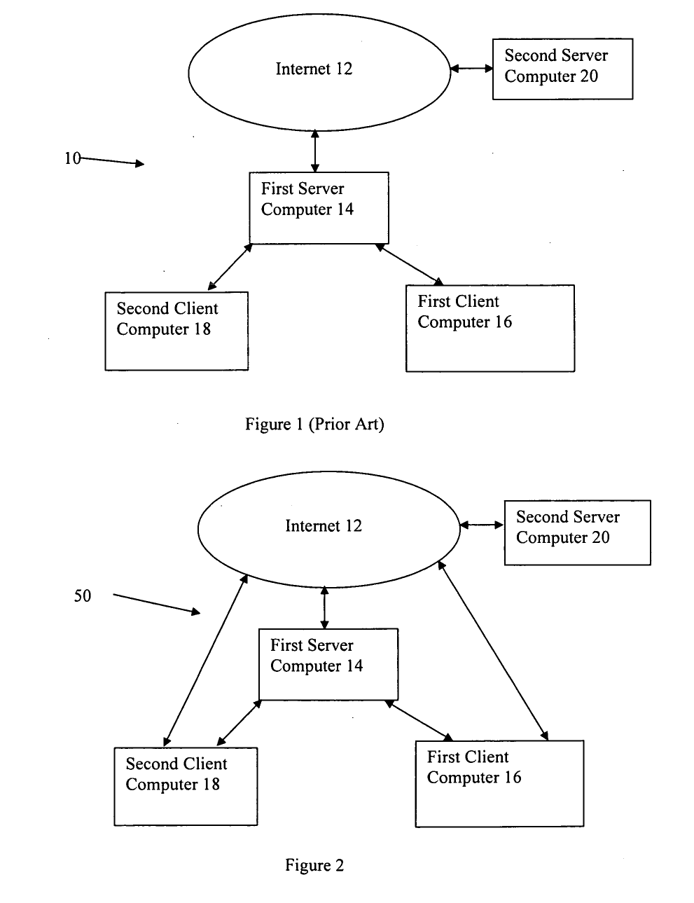

Referring to FIG. 2 there is shown a block level diagram of a system 50 for carrying out the present invention for collaboratively browsing the Internet 12. The system 50 is similar to the system 10, shown in FIG. 1. Hence, like numerals will be used for similar components. The system 50 comprises a first server computer 14 connected to the Internet 12. Thus, the first server computer 14 is a part of the Internet. However, for discussion purpose, the first server computer 14 will be referred to as being separate from the Internet 12. A first client computer 16 is capable of being connected to the Internet 12, as well as to the first server computer 14, through the Internet 12 (although for illustration purpose, a direct connection from the first client computer 16 to the first server computer 14 is shown). A second client computer 18 is connected to the first server computer 14, as well as to the Internet 12. Finally, a second server computer 20 is connected to the Internet 12. The second server computer 20 contains the website of interest. The second server computer 20 has a unique URL address, so that client computers, such as first client computer 16 and second client computer 18, can access the website 20 of interest.

The first client computer 16 can access the Internet 12 in the usual manner whereby the first user of the first client computer 16 can browse the Internet 12. Thus, the first client computer 16 executes a well known browser application program such as Internet Explorer or Mozilla's Firefox. In the preferred embodiment, the computer program code of the present invention, typically in Javascript code, is embedded at or referenced by the website 20 of interest and is downloaded, and executed by the web browser application program running on the first client computer 16, when the website 20 of interest is accessed. However, as will be seen, the present invention also contemplates the computer program code for carrying out the present invention to be either a web browser extension program, or is integrated with the web browser application program. Thus, initially, the discussion will be with regard to the computer program code of the present invention being embedded at or referenced by the website 20 of interest. Further, the discussion will initially relate to the simple case where the website 20 of interest does not contain any AJAX or Flash.

### Establishing Communication Protocol

In a first embodiment, when the first user at the first client computer 16 browses the website 20 of interest, the code and objects from the website 20 can include code and objects for the image of a user activatable button. The image of a button may bear a notation of “CO-SHOPPING” or “SHOP WITH A FRIEND” to denote that upon activation, the first user will then have the ability to mutually co-browse the website 20 with a friend. When the image of the user activatable button is so activated, a computer program code, preferably in Javascript code is then downloaded from the first server computer 14 to the first client computer 16 for execution by the web browser application program running on the first client computer 16. The image of the activatable button is embedded at the website 20, but the activation thereof provides a link or reference to the computer program code stored in the first server computer 14. As is well known a computer, whether a server computer (such as 14 or 20) or a client computer (such as 16 or 18), has a storage device, such as a hard disk drive to store the relevant program code. Alternatively, in the preferred embodiment, the code and objects from the website 20 has a link to the image of the activatable button from the first server computer 14. Thus, each time the website 20 is accessed, the first client computer 16 loads the code and objects from the website 20 as well as causing code and objects of the image of the activatable button from the first server computer 14 to be sent to the first client computer 16. The display of the code and objects from both the website 20 as well as the code and objects for the image for the activatable button from the first server computer 14 causes an image to be composed on the display device associated with the first client computer 16, as if it were an image with the activatable button from the website 20. Once the image of the activatable button is activated, the aforementioned computer program code is downloaded to the first client computer 16 from the first server computer 14.

There are a number of advantage/disadvantages to each method. In the former, as the website 20 is accessed, the code and objects of the image of the activatable button are downloaded from the website 20 along with other code and objects from the website 20. Further, once the image of the activatable button is activated, the computer program code is downloaded from the first server computer 14. In the latter, as the website 20 is accessed the code and object of the image of the activatable button is downloaded from the first server computer 14, along with other code and objects from the website 20. Thus, comparing the latter to the former there may be more latency at the first client computer 16 when all the code and objects from both server computers 14 and 20 are retrieved and re-assembled into a web image. However, with the latter, one can change the code and objects of the image of the activatable button, without disturbing the code and objects at the second server computer 20.

The Javascript code downloaded from the first server computer 14, after the activation of the activatable button, then causes the first client computer 16 to initiate a communication session. In particular, the downloaded Javascript code when executed causes the first client computer 16 to notify the first server computer 14 of its desire to connect or establish communication. This can be accomplished by the use of conventional initiation with a buddy list in accordance with well known protocol, such as Gmail chat, or ICQ chat or AOL chat, which will be discussed in greater detail hereinafter. The Javascript code then prompts the first user at the first client computer 16 to select the identity of the second user (at the second client computer 18) with whom the first user desires to communicate. Where the website 20 of interest is not a private site that requires a log-on (such as facebook, or myspace etc.) or has AJAX or Flash, the request for establishing a chat session with the second client computer 18 also includes the URL or address of the website 20 of interest sent to the second computer 18, through the first server computer 14.

When the first user at the first client computer 16 initiates the chat session, the signal is sent to the first server computer 14, which causes a window 36 for chat to be opened in a portion of the display device of the second client computer 18 in accordance with well known techniques. The window 36 may be located in any location on the display device and may contain a message to establish the protocol for the chat session, such as the “First Client Computer 16 wishes to shop and chat with you about the following website:” followed by the URL of the website 20 of interest.

The URL that is displayed on the chat window 36 of the display of the second client computer 18 may differ slightly from the URL of the website 20 of interest initially accessed by the first client computer 16, in the following manner. Assume the URL of the website 20 of interest accessed by the first client computer 16 to be http://www.ABC.com. However, the URL which is displayed in the chat window 36 of the second client computer 18 may be the following: http://www.ABC.com&value=true. The difference is as follows. When the first client computer 16 accessed the website 20 of interest using the URL http://www.ABC.com, a “CO-SHOPPING” or “SHOP WITH A FRIEND” button appeared on the screen 34 of the display device of the first client computer 16. However, since the first user has already activated that “CO-SHOPPING” or “SHOP WITH A FRIEND” button, it is no longer necessary to display that button (to the second user, who has been invited to co-browse the website 20), when the second user is directed to the website 20. Thus, the URL http://www.ABC.com&value=true, is accessing the same URL as the URL accessed by the first client computer 16, but with the variable “value” being set to “true”. Thus, the code within the website of http://www.ABC.com recognizes that the variable value=true, means that the person, or the second user, accessing that website 20 has already been invited to co-browse. In that event, when the URL http://www.ABC.com&value=true is accessed, what is displayed in the screen portion 34 is the same information as on the display of the first client computer 16.

The invitation to co-browse is initiated through a conventional Instant Message (IM) chat window through conventional IM chat programs such as Gtalk, AIM, MSN Messenger etc. Once the chat is initiated, the chat window 36 is displayed in a portion 36 of the display area of the second client computer 18. Along with the chat box 36 and preferably adjacent thereto is also a small display box 38 showing objects from the website 20 of interest that is being viewed by the first user on the first client computer 16. In the preferred embodiment, the content of the small display box 38 is an image of the Product ID code that is being viewed by the first user on the first client computer 16. The Javascript code from the website 20 causes the first client computer 16 to determine objects from the webpage being viewed on the display device of the first client computer 16 to be sent to the second client computer 18. These objects include: a link to the image of the Product ID code, the Price ID code, the title of the Product, and the URL of the page that is being viewed. Once the second client computer 18 receives the URL and accepts the invitation to CO-SHOP, it accesses the webpage 20 of interest provided by the first user from the first client computer 16. The webpage 20, as previously discussed contains or provides links to the Javascript code of the present invention which is also downloaded to the second client computer 18. When the downloaded Javascript code is executed by the second client computer. 18, it causes the browser of the second client computer 18 to retrieve the image of the Product ID based upon the link to the Product ID provided by the first client computer 16. That image is then displayed in the small display box 38 of the display device associated with the second client computer 18. In addition, the title of the Product and the Price ID code are displayed in the title portion 40 of the miniature display 38. Alternatively, the image for the Product ID (rather than a link thereto) shown in the display box 38 can be supplied by the first server computer 14 received from the second server computer 20 or it can be from the first client computer 16. In addition, the image contained in the miniature display box 38 can be a full image of the webpage 20 that is being viewed by the first user at the first client computer 16. This can be done by the browser of the second client computer 18 retrieving the webpage 20 based upon the URL supplied by the first client computer 16. The disadvantage of displaying a full webpage 20 in a miniature display box 38 is that the size of the image displayed would be too small. The chat window 36 and the miniature display window 38 are typically small windows that overlay the main display area 34.

When the second user at the second client computer 18 clicks the URL http://www.ABC.com&value=true, the second client computer 18 accesses the Internet 12 to reach that address. The second server computer 20 supplies the code and objects of the website 20 to the second client computer 18 for display and supplies the Javascript code of the present invention, to the second client computer 18 for execution. The Javascript code of the present invention embedded in or referenced by the website 20 causes the URL of the address being viewed by the second user on the display device of the second client computer 18 (in this case, also website 20) to be sent to the first server computer 14 and to the first client computer 16, along with the objects of a link to the Product ID code, the Price ID code and the title of the Product. The first client computer 16 after receiving the link of the Product ID code from the second client computer 18 (through the first server computer 14) would open the miniature display window 38, which overlies the display area 34 and retrieve from the link provided the image of the Product that is being displayed on the display 34 of the second client computer 18.

Once this initial communication is established the display area 34 on the display device for each of the first client computer 16 and the second client computer 18 would contain the same web page 20. In addition, the miniature display device 38 for each of the display devices associated with the first and second client computers 16 and 18 would contain the image of the same product. Thereafter, however, if the first user at the first client computer 16 browses to a subpage within the website http://www.ABC.com, then the Javascript program code from that subpage is downloaded to the first client computer 16. The Javascript program code from that subpage causes the URL of the subpage to be sent to all the other users that the first user had established chat communication with. In short, a socket to the first server computer 14 is kept alive from the first client computer 16 (along with all the other client computers, such as the second client computer 18 also keeping its socket connection alive to the first server computer 14). In this manner all of the other client computers are able to receive the new subpage information as soon as the new subpage is loaded onto the first client computer 16. In addition, the Javascript code program from the subpage causes the link of the image of the Product ID, the title of the Product and the Price ID of the Product to be sent to all of the other users with whom the first user had established a communication session.

In addition, whatever chat that is sent by the second user at the second client computer 18 or the first user at the first client computer 16 is sent to the first server computer 14, which would fill the content of chat window 36 (which will be discussed hereinafter) with the chat from the second client computer 18 or from the first client computer 16 as the case may be.

Alternatively, in the method of the present invention, the computer program code of the present invention can reside at the first server computer 14 to poll constantly both the first client computer 16 and the second client computer 18 to determine changes in the webpage being viewed as well as the status of the chat. Thus, the method of the present invention envision both the so called “Asynchronous Push” technology as described hereinabove, wherein changes, such as chat or display of a different subpage, are communicated as soon as they occur through the action of Javascript code downloaded from each webpage, or the alternative embodiment of the so-called “Synchronous Pull” technology wherein polling for changes occur periodically, by the first server computer 14 polling each of the first or second client computers 16 or 18 respectively.

### Mutual Co-Browse

Immediately after the protocol for communication has been established between the first user on the first client computer 16, and the second user on the second client computer 18, each user is free to navigate or surf the Internet 12. So long as both users are surfing on the domain of the website 20 of interest, e.g. http://www.ABC.com, then each user will see in the miniature display box 38, the product from the web page that the other user is viewing, despite being on different subpages. This is because the Javascript code is in a template from the website 20, and its subpages. However, once a user navigates away from the website 20 including its subpages, to another website that does not have the Javascript code of the present invention, then the ability to co-browse would end. Furthermore, since the website 20 has the Javascript code, the creation of a separate window 38/36 within the main window 34 would not cause a frame busting event.

To mutually co-browse, if, for example, the domain http://www.ABC.com is a shoe store, and each sub page of the domain http://www.ABC.com represents a different brand of shoe, then if a first user is viewing the web page of http://www.ABC.com/nike, and the second user is viewing the web page of http://www.ABC.com/addidas, then the first user will see Nike shoes in display on the main display portion 34, while at the same time will see image of an Addidas shoe that the second user is viewing in the small display box 38 of the display of the first client computer 16. Similarly, the second user will see Addidas shoes in display on the main display portion 34, while at the same time see an image of a Nike shoe that the first user is viewing in the small display box 38 of the second client computer 16. The manner in which this is accomplished as is follows. Embedded within each subpage of the website 20 is the Javascript code of the present invention that causes e.g. the first user to send to the first server computer 14 the URL of the website it is viewing, along with other relevant information, such as link to image of Product, title and price. When each new subpage loads, the Javascript code from that subpage is executed. The Javascript code captures all the relevant objects of that subpage (e.g. the URL of the subpage, product title, price, image or link to the image of the product, etc.) and then using the socket to the first server computer 14 that is kept alive (i.e. without the need to re-establish connection with the first server computer 14) the new information is sent to the first server computer 14 to be sent to all other client computers which are kept alive with the first server computer 14, that are established in this co-shopping session.

Specifically, in one embodiment of the present invention, in most websites constructed today, each webpage has a Product ID code and a Price ID code in the same location within the different pages. The Product ID code refers to the location where the product image will be displayed. With this common template, an on-line store can create a consistent look and feel for each product page. The Price ID code refers to the price associated with the products. The Javascript code of the present invention seeks out the Product ID code and the Price ID code from each webpage. The image that is retrieved from the webpage based upon the Product ID code is then sent to the display of the other user for display in the miniature display 38. Alternatively, the first server computer 14 can retrieve the website that the first user is viewing and reformat it into a miniature display 38 and send the miniature display to the second client computer 18. The advantage of this alternative embodiment is that the entire webpage is displayed in the miniature display 38. However, this requires considerable bandwidth and further if the entire webpage is displayed, the image may be small.

In another aspect of the present invention, in the event, either the first user or the second user wants to join and see the display in the main portion of the display 34, what the other user is viewing, the user clicks on the small display box 38. In that event, the code and objects associated with the webpage in the small display box 38 fills the main display portion 34. In this manner, each user can see in its main display 34 the website of interest as well as in the small display 38 the website that is being viewed by the friend, and instantly view the website shown in the small display 38 to join in the discussion of the same website. The manner in which this is accomplished is as follows. Because each user, e.g. the first user is sent the URL of the page that the other user is viewing, when the first user clicks on the portion of the display device 38 with a point device, such as a mouse, the Javascript code of the present invention recognizes this action and causes the browser program of the first client computer 16 to retrieve the code and objects of the webpage from the URL sent by the second user from the second client computer 18. The code and objects of that webpage are then displayed in the main display 34.

While the foregoing describes the operation of co-shopping with a single “friend” the present invention is not so limited. The first user when initiating the initial chat session can invite a plurality of “friends” and each of the plurality of friends will see in his/her small display area 38, what the first user sees on the main display 34. In this manner the present invention contemplates group co-shopping.

### Ajax

In the event the website 20 of interest contains Ajax technology, the following alternative embodiment of the present invention is possible. AJAX is code and objects within a web page that alters the display of the web page depending on user input (such as by clicking of a pointing device such as a mouse, or by entering alphanumeric characters, etc.) without requiring the webpage to reload from the website 20. Thus, for example, if the display device showed content from the web page http://www.ABC.com/nike, which shows different types of shoes offered by the Nike brand, and if the display shows different colored shoes, and an activatable button when activated changes the color of the shoes displayed, when the user clicks on the activatable button, and the color of the shoe is changed, the change in the state of display does not require the reloading of the page. The problem in co-browsing is knowing what state of the display the other person is viewing.

In this embodiment of the present invention, the establishment of the communication protocol is the same as discussed heretofore. However, when a user, such as a first user at the first client computer 16 changes the state of the display on the display device of the first client computer 16, the Javascript code of the present invention which is embedded within the website 20 of interest, does not send the URL of the display to the first server computer 14, because in that event the URL will not have changed. Instead, if a first user at a first client computer 16, presses an update button, the Javascript code sends the code and object of the Product ID to the first server computer 14. The first server computer 14 then forwards that code and object of the display from the first client computer 16 to be displayed in the miniature display portion 38 on the display device of the second client computer 18. Similarly, in the event the second client computer 18 were viewing in its display 34 a website 20 that has Ajax technology, when it changes the display and the second user clicks an update button, the object from that display is then transmitted to the first server computer 14 to be forwarded to the miniature display portion 38 of the display device of the first client computer 16.

### Flash

In the event the website 20 of interest contains Flash code, the following alternative embodiment of the present invention is possible. A Flash object, as is well known, can be simply a video file. However, a Flash object can also constitute a plurality of images that represent different states within the same web page from a URL. Thus, depending upon the state of that webpage, a display of the webpage at one client computer may differ from the display of that webpage at another client computer, even though both have received the same code and objects from the same URL. Thus, the problem of Flash in co-browsing is to ensure synchronicity of the two client computers, when browsing the same website of interest.

In the present invention, when a website 20 of interest contains Flash, an image of the first instance of time of the Flash object is taken by the Javascript code. That image along with the rest of the code and object is sent by, e.g. a first client computer 16, to the first server computer 14 to be displayed in the miniature display 38 at the display device of the second client computer 18.

### Chat Session

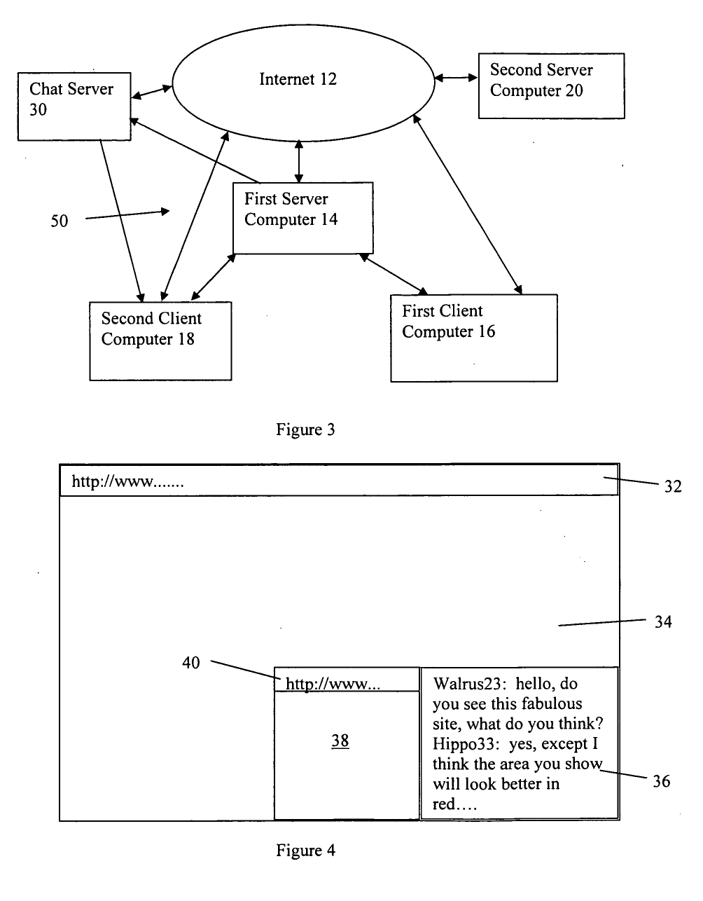

As noted above, when a first user at the first client computer 16 initiates a co-browsing session, the first user initiates a “chat” session. Referring to FIG. 3, there is shown a schematic diagram of a system showing the flow of chat information in accordance with the present invention. At the outset, it is assumed that the first user has a “chat” account at any of the well known chat providers, such as AIM, GTalk, Yahoo IM, ICQ, etc., each of which resides on a chat server 30. Assume now that prior to practicing the method of co-browsing of the present invention, the first user at the first client computer 16 and the second user at the second client computer 18 are not in a “chat” session. Then the “chat” is commenced by the first user at the first client computer 16 activating or clicking the “CO-SHOPPING” or “SHOP WITH A FRIEND” button as discussed hereinabove. The activation of the “CO-SHOPPING” or “SHOP WITH A FRIEND” button, causes the Javascript code of the present invention to “call” the first server computer 14 and causes the first server computer 14 to initiate a log-in at the chat server computer 30 (assuming that the first user has not already logged in, since it is possible for the first user to log in once and to be kept logged in). Assuming that the first user has not already logged in at the first server computer 14, a window 36 overlaying the browsed window 34 on the display device associated with the first client computer 16, appears. The first user is asked to provide information in the window 36 which includes the first user's name, password, and the domain of the chat server 30 that the first user has a chat account with, such as AOL, GTalk, Yahoo IM, ICQ, etc. The first user enters the aforementioned requisite information which is sent to the first server computer 14. The first server computer 14 in turn logs onto the chat server computer 30 using the first user's name and password provided at the domain of the chat server 30. Thus, to the chat server computer 30, it is as if the first server computer 14 is logging on. Once the log-in is verified by the chat server computer 30, the chat server computer 30 returns a list of the “buddies” with whom the first user can chat. That list is returned to the first server computer 14 which is then sent back to the first client computer 16 and displayed in the window 36. The first user then selects the name of one or more of the “buddy” (second user) that he/she wants to chat with by highlighting the name, and then clicking an “invite” button within the chat display portion 36.

Upon the clicking of the “invite” button, the name of the second user (or a plurality of other users) is sent to the first server computer 14. The first server computer 14 then sends the list to the chat server computer 30. The first server computer 14 further supplies the chat server 30 an invitation to co-browse for the buddy (or buddies) selected, by the message “First Client Computer 16 wishes to shop and chat with you about the following website:” followed by the URL of the website 20 of interest. The chat server computer 30 sends the invitation message to the second client computer 18. In the event the second user (invited buddy) at the second client computer 18 accepts the invitation to co-browse, by clicking on the URL link provided in the invitation from the chat server computer 30, the web browser of the second client computer 18 retrieves the code and objects from the URL set forth in the invitation all as described heretofore.

However, in the event the second user at the second client computer 18 responds by sending a chat message, the chat message is sent directly to the first server computer 14, by passing the chat server computer 30. Once communication protocol is established, the chat server computer 30 is no longer involved in the communication between the second client computer 18 and the first server computer 14 (which is acting like the first client computer 16). Although the chat server computer 30 is no longer involved in the chat communication between the second client computer 18 and the first server computer 14 (and then to the first client computer 16) in the preferred embodiment, it is preferable that the first server computer 14 remain “logged on” to the chat server computer 30. This provides the added advantage that in the event the first user desires to chat or invite other users (other than second user) to co-browse, the first user will no longer need to log on to the chat server computer 30 (by supplying the first user's name and password, and subject to verification by the chat server computer 30). Thereafter, the chat session between the first client computer 16 and the second client computer 18 passes through the first server computer 14.

Once communication is established between the first server computer 14 and the second client computer 18, the URL of the web page (along with the other objects discussed heretofore) which is being viewed by the first client computer 16 (first URL) is sent in the manner described above, to the first server computer 14, which is further sent to the second user at the second client computer 18, where the browser of the second client computer 18 retrieves the code and object of the first URL. As discussed, the Javascript code from the first URL also causes the second client computer 18 to display the image of the product that is being viewed at the first client computer 16 to retrieve and display in the miniature display 38 of the second client computer 18's display device, using the link to the image of the Product ID. Thus at the display device of each user, the browsed page of that user is shown in a first window 34, with the chat with the other user in a separate second window 36, overlaying a portion of the main display 34, with the miniature display 38 containing the image of the product that is being viewed by the other user.

Referring to FIG. 4 there is shown schematic a diagram of a screen shot showing the display on the monitor or display device of the first or second client computer 16 or 18, respectively. The display portion shown in FIG. 4 shows a first displayed portion 32, and the main display portion 34. The main display portion 34 displays the web page that is browsed by the first client computer 16 whose URL is shown in the first display portion 32. A separate chat content window 36 is displayed in a third display portion 36, and a miniature window 38 showing the display of the Product image being viewed by the other user is shown in the miniature display 38. The displays 36 and 38 overlay portions of the main display 34.

There are a number of variations of the present invention. First, in the event the Javascript code is a large file, some or all of the Javascript code may not be loaded with the web page 20 when it is initially retrieved. Some or all of the Javascript code file may be “downloaded” to the first client computer 16 only after the “CO-SHOPPING” or “SHOP WITH A FRIEND” button is activated. Since not all users accessing the web page 20 may desire to co-browse, the “downloading” of the Javascript code only after the “CO-SHOPPING” OR “SHOP WITH A FRIEND” button is activated means that those users who do not co-browse, would not experience any delay in viewing the web page 20.

Another variation is that the present invention can be practiced with any private network within the Internet 12, such as social network site, such as Myspace or Facebook etc., in which the network has an application platform that permits the installation of Javascript code. In that event, when a user (either the first or the second) is logged into the private network, the user can participate in the co-browsing experience without leaving the private network. Furthermore, the first server computer 14 may also be integrated with the second server computer 20 that contains the browsed website 20. Thus, with this embodiment, co-browsing by users logged into a private network can be experienced by the user without leaving the private network.

There are many variations of the present invention possible. For example, in an alternative embodiment, the chat between the first client computer 16 and the second client computer 18 is not limited to instant messaging chat. The chat can also be VOIP (Voice Over IP), or even video chat.

There are many applications of the method and program of the present invention. First, as described above, the program of the present invention can reside at the website 20. In that event, when a first user at the first client computer 16 browses the Internet 12, using a conventional browser, and reaches the website 20, the first user can “click” a button or other indicia to initiate the program of the present invention from either second server computer 20 or from the first server computer 14. However, the program of the present invention can also be a separate extension of a browser. In that event, a user would not need to click on any indicia or button to “download” the program code, The program code will already reside as an extension of the browser program on the client computer 16 or 18. Finally, of course, the program code of the present invention can be integrated into a web browser program. The problem of the program of the present invention being an extension of a web browser program or even integrated with the web browser is that both first user and the second user must have the program in its browser (or in the extension). However, by using Javascript code, i.e. the program residing on the website of interest, and being downloaded to the user when desired, it means that it is available without regard to whether the second user has the program of the present invention in its web browser or extension.

What is claimed is:

1. A method of browsing a plurality of websites, each having an address associated therewith, from a network of interconnected computer networks (“Internet”) comprising:
receiving first code and objects from a first website from the Internet by a first computer;
displaying said first code and objects of said first website on a first display area of a first display device of said first computer;
receiving second code and objects from a second website from the Internet by a second computer;
displaying said second code and objects of said second website on a second display area of a second display device of said second computer;
transmitting a first address associated with said first website by said first computer to a server computer to send to said second computer;
retrieving a first object from said first address by said second computer; and
displaying said first object from said first address in a first portion of the second display area of the second display device of the second computer, wherein said first portion overlays a portion of the second display area.

2. The method of claim 1 further comprising:
communicating between said first computer and said second computer through said server computer.

3. The method of claim 2 wherein said communicating is by instant message chat.

4. The method of claim 3 wherein said communicating is displayed in a second portion of the second display area of the second display device of the second computer.

5. The method of claim 4 further comprising:
transmitting a second address associated with said second website by said second computer to a server computer to send to said first computer;
retrieving a second object from said second address by said first computer;
displaying said second object from said second address in a third portion of the first display area of the first display device of the first computer, wherein said third portion overlaps a portion of the first display area.

6. The method of claim 5 further comprising the step of polling said first computer and said second computer by said server computer to determine the address of the website whose code and objects is displayed on the display area of the display device of said first computer and second computer respectively.

7. The method of claim 1 further comprising the step of transmitting by first computer or said second computer to the other the address of the website displayed on the first or second display area of the display device associated with the first computer and the second computer respectively.

8. The method of claim 7 further comprising the step of clicking said first portion of the second display area of the second display device of the second computer to cause the display of said first code and objects of said first website to be displayed in the second display area on the second display device of said second computer.

9. A computer program embodied in a machine readable storage medium for reference by a website having a first address, for downloading to and execution by a first computer, said computer program comprising:
computer program code configured to cause said first computer to initiate a communication session through a server computer with a second computer; and
computer program code configured to cause said first computer to transmit to said server computer said first address.

10. The computer program code of claim 9 wherein said computer program code is configured to cause said first computer to communicate by instant message chat through a server computer with a second computer.

11. The computer program code of claim 9 wherein said computer program code is configured to cause said first computer to communicate by VOIP through a server computer with a second computer.

12. The computer program code of claim 9 wherein said computer program code is configured to cause said first computer to communicate by video chat through a server computer with a second computer.

13. The computer program code of claim 10 wherein said computer program code further configured to cause said first computer to display and permit activation of menus in a display of instant message chat.

14. A server computer program embodied in a machine readable storage medium for execution by a server computer, said server computer program comprising:
computer program code configured to receive identification data for logging a first user from a first computer on to a chat server computer, and the identification of a second user with whom the first user desires to communicate;
computer program code configured to log on to the chat server computer and to initiate communication with the second user, as if the server computer were the first computer;
computer program code configured to communicate directly with the second user at a second computer and with the first user at the first computer once communication is established by the chat server computer, and by-passing the chat server computer.

15. The server computer program of claim 14 further comprising
computer program code configured to receive an address of a website from the first computer, which received code and objects from the website from a network of interconnected computer networks (“Internet”); and
computer program code configured to embed the address in the communication with the second user.

16. The server computer program of claim 15 further comprising:
computer program code configured to poll said first computer and said second computer periodically to determine the address of the Internet at which the first or second computer has accessed.

17. A web browser computer program embodied in a machine readable storage medium for execution by a first computer, said web browser computer program comprising:
computer program code configured to cause the first computer to receive first code and objects from a first address of a website from a network of interconnected computer networks (“Internet”), and to display same on a first display;
computer program code configured to transmit said first address to a server computer, for delivery to a second computer; and
computer program code configured to receive from said server computer in a portion of the first display an object from a website displayed at said second computer.

18. The web browser computer program of claim 17 further comprising:
computer program code configured to respond to activation of said portion of the first display by displaying on said first display code and objects from the website displayed at said second computer.

19. The web browser computer program of claim 18 further comprising:
computer program code configured to initiate a communication session with said second computer through said server computer.

20. The web browser computer program of claim 18 wherein said computer program code configured to receive from said server computer in a portion of the first display further comprising computer program code configured to display in said portion communication from said second computer received through said server computer.

21. An extension computer program for a web browser computer program embodied in a machine readable storage medium for execution by a first computer, said extension computer program comprising:
computer program code configured to cause the web browser computer program of the first computer to receive first code and objects from a first address of a website from a network of interconnected computer networks (“Internet”), and to cause the web browser computer program to display same on a first display;
computer program code configured to transmit said first address to the server computer, for delivery to a second computer; and
computer program code configured to receive from said server computer and to cause said web browser computer program to display in a portion of the first display an object from a website displayed at said second computer.

22. The extension computer program of claim 21 further comprising:
computer program code configured to respond to activation of said portion of the first display to cause the web browser computer program to display on said first display, code and objects from the website displayed at said second computer.

23. The extension computer program of claim 22 further comprising:
computer program code configured to initiate a communication session with said second computer through said server computer.

24. The extension computer program of claim 23 wherein said computer program code configured to receive from said server computer and to cause said web browser computer program to display in a portion of the first display further comprising computer program code configured to cause said web browser computer program to display in said portion communication from said second computer received through said server computer.
